(19) United States
(12) Patent Application Publication
(10) Pub. No.: US 2021/0238056 A1
(43) Pub. Date: Aug. 5, 2021

(54) A SYSTEM FOR MONITORING FOULING ISSUES IN A DRINKING WATER DISTRIBUTION NETWORK

(71) Applicant: OASEN N.V. [NL/NL], Gouda (NL)

(72) Inventors: Walterus Gijsbertus Joseph VAN DER MEER, Gouda (NL); Gang Liu, Gouda (NL)

(21) Appl. No.: 17/255,673

(22) PCT Filed: Jul. 1, 2019
(86) PCT No.: PCT/NL2019/050406

§ 371 Date: Dec. 23, 2020

(30) Foreign Application Priority Data
Jun. 29, 2018 (NL) 2021215

(51) Int. Cl. C02F 1/00; B01D 27/10; B01D 35/143; B01D 37/04

(52) U.S. Cl. CPC C02F 1/004; B01D 27/101; C02F 2307/14; B01D 37/046; B01D 35/143

(57) ABSTRACT

The present invention relates to a system for monitoring fouling issues in a drinking water distribution network, said drinking water distribution network comprising a water mass flow meter having a water inlet and a water outlet, said water mass flow meter being located at a customer, wherein upstream from said water mass flow meter a filter device is positioned, said filter device being provided with a pre-pressure sensor and a post-pressure sensor.

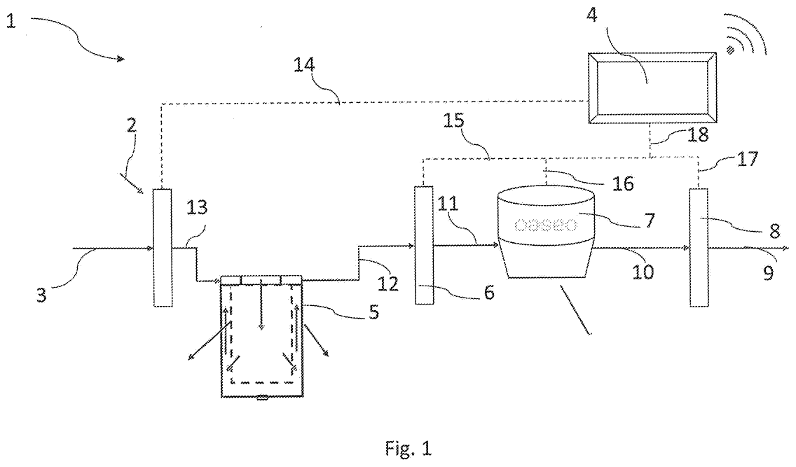

The present invention relates to a system for monitoring fouling issues in a drinking water distribution network comprising a water mass flow meter having a water inlet and a water outlet, the water mass flow meter being located at customer. Such a system is not only related to monitoring, but focusses also on studying the reasons of the detected fouling issues. In addition, the present invention relates to a method for monitoring fouling issues and to figure out what matters contribute to the water meter clogging issues.

Monitoring systems in a drinking water distribution network are well known. For example, a device for on-line monitoring of membrane fouling during a filtration process comprising a membrane whose edges are clamped between top and bottom plates is known from NL1028474. Such a device for on-line monitoring of membrane fouling during a filtration process comprises a membrane module with a feed stream inlet, a product stream outlet and a feed stream outlet. The membrane module comprises a membrane whose edges are clamped between top and bottom plates.

Another monitoring system in a drinking water distribution network is known from US 2009/045144. That US publication discloses a monitoring system and a method for monitoring a reverse osmosis (RO) membrane in an RO unit, i.e. detecting the formation of mineral salt crystals on the surface of the RO membrane. The monitoring system disclosed therein includes a reverse osmosis monitoring cell coupled to the RO unit so as to receive a sample stream taken from either the feed stream to, or the concentrate stream from, the RO unit. The cell has a visually observable RO membrane that is visible to an imaging system that creates and collects images of the visually-observable RO membrane, and that conveys an image data signal to a data processing system that is operable to translate the image data signal into visual images for display, and to correlate the data in the image data signal with a scaling condition on the RO membrane in the RO unit.

EP 1 791 616 relates to a method of characterizing a fouling status and a change therein of a fluid to be filtered and a filter medium. Filtering fluids to remove contaminants is generally known in the art. When filtering a fluid in order to remove contaminants, a filter will be used on which part of the contaminants is deposited in the form of a filter cake. Depending on the nature of the material that is filtered off, this filter cake may vary greatly, for example, it may be a compressible, a non-compressible or a compactable filter cake. Also, the material filtered off may clog the pores of the filter to a greater or lesser degree or may, for example, be adsorbed to the filter material.

An article of Gang Liu et al titled “Potential impacts of changing supply-water quality on drinking water distribution: A review”, Water Research, Volume 116, 1 Jun. 2017, Pages 135-148, discloses a situation wherein the water quality may be impacted during its distribution through piped networks due to the processes such as pipe material release, biofilm formation and detachment, accumulation and resuspension of loose deposits. Irregular changes in supply-water quality may cause physiochemical and microbiological de-stabilization of pipe material, biofilms and loose deposits in the distribution system that have been established over decades and may harbor components that cause health or esthetical issues (brown water). This article reviews the contaminants that develop in the water distribution system and their characteristics, as well as the possible transition effects during the switching of treated water quality by destabilization and the release of pipe material and contaminants into the water and the subsequent risks. For example, biofilm matrix problems, i.e. bio-chemical and microbiological destabilization, may lead to cell release, particle generation, water meter clogging and discoloration.

International application WO 2014/171400 relates to a method and a device for real time monitoring the slime-adhesion status of a water system. Water sampled from a water system (raw water) is passed through a hollow fiber membrane using a cross-flow method, and a slime-adhesion status of the hollow fiber membrane module is monitored on the basis of changes in the pressure difference between the raw water inflow side and permeated water outflow side. Using a cross-flow method changes in the slime-adhesion status are continuously metered on the basis of pressure changes before and after the membrane caused by slime adhering to the hollow fiber membrane surface. In addition, the system also measures the change in the dissolved oxygen (DO concentration) of the permeated water relative to raw water. On basis of this, one can confirm whether or not the change in the membrane differential pressure is a factor other than slime.

Biofilms are aggregates of microorganisms on surfaces/interfaces and are bound by an extra-cellular polymeric matrix. In that context, WO 2016/153428 discloses a method of analyzing biofilm development, the method comprising quantifying biofilm development in the flow cell apparatus including a channel plate having a channel recessed into a surface of the channel plate, and a groove recessed into the surface of the channel plate, the groove configured to surround the channel and preferably along a boundary of the channel.

The drinking water distribution network is a sealed and pressurized system which attached numerous biofilm and microorganism due to the long-time operation. In a foreseeable future, drinking water suppliers may adopt reverse osmosis (RO) to treat drinking water and thus the nutrient (biodegradable compounds) in drinking water will be slight. In such a situation, biofilms used to attach on pipelines may die and detach from pipes and these part of biofilm may clog consumers' water meter.

The present applicant is focused to provide even more safe water to the consumers, and the introduction of one-step reverse osmosis (one-step RO), to replace the conventional treatment is the result thereof. One-step RO is to let the ground water directly go through RO membrane and nearly only water could pass through RO membrane. Therefore, drinking water from treatment plant is almost the pure water. On one hand, using RO water can significantly improve the drinking water quality and also control the microbial growth during distribution process because biologically stable water can limit the growth of any kinds of bacteria by controlling the food source. On the other hand, because the RO water is so pure and the nutrient concentration is almost zero, lots of biofilm and microorganisms attached on pipelines over the past decades may die because of the lacking of enough food and detach from pipelines. These detached biofilms and microorganisms present in water in pieces and may clog water meters.

A drinking water distribution system is the final and essential step to transfer safe and high-quality drinking water to customers. One of the functions of such a system is preventing bacterial intrusion. However, some biological processes, such as biofilm formation and detachment, microbial growth in bulk water, and the formation of loose deposits, may occur. These processes will cause the deterioration of the water quality during the distribution process. In some extreme situation, pathogens may regrowth and cause a health risk to consumers.

It is, therefore, necessary to develop an effective method to monitor the water quality during the distribution process.

In addition, to avoid the potentially clogged water meter issues, a monitor method is needed to monitor the fouling issues during the distribution process.

Another aspect of the present invention is related to investigating the reasons why several issues occur, i.e. clogging of water meter, changes of water quality, by measuring several process parameters of the system.

The present invention is thus related to a system for monitoring fouling issues in a drinking water distribution network, the drinking water distribution network comprising a water mass flow meter having a water inlet and a water outlet, the water mass flow meter being located at a customer, characterized in that upstream from the water mass flow meter a filter device is positioned, the filter device being provided with a pre-pressure sensor and a post-pressure sensor.

On basis of such a system one or more objects of the present invention will be achieved. The present inventors found that the pressure drop is the key factor to detect the fouling issue and two equipment, filtrated clogging potential (FCP) and crossflow clogging potential (CCP), are identified to monitor the fouling issues both in a short term and long term. According to the present invention the system for monitoring fouling issues in a drinking water distribution network can not only measure the water flow but also can monitor clogging potential by detecting the pressure drop increase and act as an early warning system, which let the drinking water supplier know and deal with clogging issues before complaints from consumers. The system for monitoring fouling issues in a drinking water distribution network can thus detect the fouling issues by monitoring the pressure drop increase. In fact, the present system can be used to monitor both regular operation water quality changes, and the special occasions of water quality deterioration in distribution systems (for example, water meter clogging and discolored water) that are caused by upgrading treatments (RO, or other water treatments, nanofiltration (NF), activated carbon etc.) or switching source water. The present inventors found that through the presence of such a filtration device it is now possible to study the reasons why clogging of water meter, changes of water quality occur by measuring the pressure drop and characterizing what causes the pressure drop.

In an embodiment of the present system the filter device is provided with a replaceable filter bag, the filter bag being suitable for analyzing deposits present in the drinking water distribution network.

Such a filter bag is contained in a filter housing. If the two pressure sensors installed individually before and after the filter bag monitor an uncommon pressure difference, the filter device will be opened and the filter bag will be taken from the filter device. The filter bag can be analyzed for deposits present in the filter bag. The distribution of drinking water can be continued by replacing the old filter bag by a new filter bag. Thus, the delivery of drinking water will not be interrupted for a long time.

In an embodiment of the present system a temperature sensor is positioned upstream from the water mass flow meter. As for the monitoring system, the present system is thus assembled with a conventional water meter, a temperature sensor, two pressure sensors installed individually before and after the filter bag as well as a filter bag contained in a filter housing. There are preferably also three valves included for sampling, filter bag replacement and maintenance.

In an embodiment of the present system the pre-pressure sensor and the post-pressure sensor generate signals, wherein the signals thus generated are sent to a monitor box. In the monitor box the data is collected and processed. A monitor box includes microprocessor(s) for collecting, processing and displaying data. An example of a monitor box is a computer that can be instructed to carry out sequences of arithmetic or logical operations automatically via computer programming. Such a computer has the ability to follow generalized sets of operations, called programs. These programs enable computers to perform an extremely wide range of tasks. An example of a monitor box including the hardware, the operating system (main software), and peripheral equipment required and used for full operation is here referred to as a computer system. This term may as well be used for a group of computers that are connected and work together, in particular a computer network or computer cluster.

In an embodiment of the present system the temperature sensor generate signals, wherein the signals thus generated are sent to a monitor box. In the monitor box the data is collected and processed.

In an embodiment of the present system the mass flow meter generate signals, wherein the signals thus generated are sent to a monitor box. In the monitor box the data is collected and processed.

The transport of signals as discussed above may take place via interconnected computer networks, such as the internet. Thus there is a sort of an on-line updating system. According to this system it is now possible to precisely log data, for example for every 8 seconds, and once accessing to an available internet such as Wi-Fi at customers', it can continuously update the logged data to an on-line data pool and made it visualized through a website to achieve a 24/7 monitoring without disturbing the customers.

In an embodiment the system is provided with one or more valves for taking water samples. In an embodiment the system for monitoring fouling issues in a drinking water distribution network may also include one or more bypass lines, for example a line that bypasses the filter device for continuing the water distribution to the customer. Such a situation is preferred when the distribution of water across the filter device is interrupted, for example when replacing the filter bag.

The present invention furthermore relates to a method for monitoring fouling issues in a drinking water distribution network in a system as discussed above, the present method comprising the following:
i) providing drinking water to the customer,
ii) measuring the pressure with the pre-pressure sensor,
iii) measuring the pressure with the post-pressure sensor,
iv) calculating the difference in pressure over the filter device on basis of the data generated by ii) and iii),
v) comparing the data generated by iv) with reference data, and, if the outcome of step v) is above a threshold value,
vi) retrieving the filter bag from the filter device, analyzing the deposits present on the filter bag and replacing the filter bag.

Such a method thus relates to monitor water quality and fouling issues during the distribution process wherein it is now possible to investigate what matters cause the pressure drop/filter resistance increase. And it is now also possible to analyze the characteristics of these matters. After replacing the filter bag for a new filter bag, the flow of water through the filter device is reestablished. During such a replacement of the filter bag it may be possible to continue the distribution of water to the consumer by bypassing the filter device. Once the filter bag is replaced the bypass situation can be terminated. In an embodiment of the present method the pre-pressure sensor is located upstream from the filter device. In an embodiment of the present method the post-pressure sensor is located downstream from the filter device. The reference data refer to a situation wherein no deposits are present in the filter device. Thus, any deviation from the reference date is an indication of an abnormality. For example, an increase in pressure drop/filter resistance may be indication of the presence of particles in the filter device. The reference data and the data measured by any or more sensors mentioned here may be corrected for the influence of the temperature.

According to another embodiment of the present method step ii) and iii) further include transmitting the measured pressure values to a monitor box, wherein the transmission of the signals takes place via the internet.

According to another embodiment the present method further comprises a step of measuring the temperature and transmitting the measured temperature values to a monitor box, especially via the internet.

It is also possible to measure the flow of water through the mass flow mater and to transmit the measured flow values to a monitor box, especially via the internet.

The present invention thus relates to a method for monitoring fouling issues and to figure out what matters contribute to the water meter clogging issues. Another aspect of the present invention is to analyze what matters cause the pressure drop/filter resistance increase. This is to figure out the factors contribute to the potential fouling issues, especially physical part, chemical part, and biological part. Physical part stress on explaining from pressure drop and filter resistance. Chemical part focus on determining the chemical compounds of fouling and biological part centralizes on ATP concentration. A better and comprehensive result could be obtained from the combining of analysis from these three aspects. In physical part, microscope and particle counter could be used to calculate the total clogging particle number. In chemical part, ICP-MS could be used to detect the concentration of chemicals.

The present invention will be discussed hereafter.

The sole FIGURE shows a system 1 for monitoring fouling issues in a drinking water distribution network 3. Drinking water is sent via a pre-pressure sensor 2 to a filter device 5. The inlet stream 13 enters filter device 5 and the outlet stream 12 passes through a post-pressure sensor 6. The outlet stream 11 from the post-pressure sensor 6 is sent to a water mass flow meter 7. The outlet stream 10 from the water mass flow meter 7 passes through a temperature sensor 8 and stream 9 is sent to the customer. Pre-pressure sensor 2 generates a signal 14, post-pressure sensor 6 generates a signal 15, water mass flow meter 7 generates a signal 16 and temperature sensor 8 generates a signal 17. An additional temperature sensor (not shown) may also be located upstream from water mass flow meter 7. Temperature sensor(s) may also be present at the inlet of filter device 5, or at the outlet of filter device 5. All signals 14, 15, 16, and 17, e.g. shown as a combined signal 18, are transmitted to a monitor box 4, i.e. a computer system. Filter device 5 comprises a housing in which a filter bag is placed. Inlet stream 13 is passed through the filter bag and leaves filter device as outlet stream 12. The filter bag can easily be retrieved from filter device 5. The deposits present on the filter bag can be analyzed in a lab. The system for monitoring fouling issues in a drinking water distribution network also includes one or more valves for taking water samples (not shown). Although the sole FIGURE shows that stream 13 is only connected to filter device 5, it is possible that a part of stream 13 “bypasses” filter device 5. Such a situation is preferred when filter device 5 is not suitable for passing high volumes of water. Thus, in such an embodiment (not shown), inlet stream 13 is partially sent to the inlet of device 5 and partially sent to outlet stream 12.

The transport of signals 14, 15, 16, and 17 to monitor box 4 may take place via interconnected computer networks, such as the internet. Thus there is a sort of an on-line updating system. According to this system it is now possible to precisely log data, for example for every 8 seconds, and once accessing to an available internet such as Wi-Fi at customers', it can continuously update the logged data to an on-line data pool and made it visualized through a website to achieve a 24/7 monitoring without disturbing the customers. The monitor box is preferably located at the administrator or owner of the drinking water distribution network and that the administrator or owner is thus informed about the status of possible fouling issues in the drinking water distribution network. In case the data processed in the monitor box indicate that there is indeed a fouling issue in the drinking water distribution network the administrator or owner is informed about this and can take proper measurements.

The system for monitoring fouling issues in a drinking water distribution network may also include one or more bypass lines, for example a line that bypasses the filter device for continuing the water distribution to the customer. Although the sole FIGURE shows the situation wherein one water mass flow meter is connected to a filter device, it is also possible that several water mass flow meters are connected to the same filter device. Thus, such a filter device can be used by several customers, for example in a residential area or district.

1. A system for monitoring fouling issues in a drinking water distribution network, said drinking water distribution network comprising a water mass flow meter having a water inlet and a water outlet, said water mass flow meter being located at a customer, wherein upstream from said water mass flow meter a filter device is positioned, said filter device being provided with a pre-pressure sensor and a post-pressure sensor.

2. The system according to claim 1, wherein said filter device is provided with a replaceable filter bag, said filter bag being suitable for analysing deposits present in said drinking water distribution network.

3. The system according to claim 1, wherein upstream and/or downstream from said water mass flow meter a temperature sensor is positioned.

4. The system according to claim 1, wherein said pre-pressure sensor and said post-pressure sensor generate signals, said signals being sent to a monitor box for collecting said signals and analysing said signals.

5. The system according to claim 1, wherein said temperature sensor generate signals, said signals being sent to a monitor box for collecting said signals and analysing said signals.

6. The system according to claim 1, wherein said mass flow meter generates signals, said signals being sent to a monitor box for collecting said signals and analysing said signals.

7. The system according to claim 4, wherein the transport of said signals takes place via the internet.

8. The system according to claim 1, wherein said system is provided with one or more valves for taking water samples.

9. The system according to claim 1, wherein said system is provided with one or more lines that bypass the filter device for continuing the water distribution to the customer.

10. A method for monitoring fouling issues in a drinking water distribution network in a system according to claim 1, said method comprising the steps of:
i) providing drinking water to the customer;
ii) measuring the pressure at a position before the inlet of the filter device with the pre-pressure sensor;
iii) measuring the pressure at a position at the outlet of the filter device with the post-pressure sensor;
iv) calculating the difference in pressure over the filter device on basis of the data generated by ii) and iii);
v) comparing the data generated by iv) with reference data, and, if the outcome of step v) is above a threshold value; and
vi) retrieving said filter bag from said filter device, analysing the deposits present on said filter bag and replacing said filter bag.

11. The method according to claim 10, wherein step ii) and iii) further include transmitting the measured pressure values to a monitor box.

12. The method according to claim 11, wherein said transmitting takes place via the internet.

13. The method according to claim 10, further comprising measuring said temperature and transmitting the measured temperature values to a monitor box via the internet.

14. The method according to claim 10, further comprising measuring the flow of water through said mass flow meter and transmitting the measured flow values to a monitor box via the internet.

15. The method according to claim 10, further comprising logging, for a specific time interval, of one or more signals chosen from the group of pre-pressure sensor, post-pressure sensor, temperature sensor(s), mass flow meter, and updating the logged data to an on-line data pool.

16. The method according to claim 15, further comprising visualizing the on-line data pool through a website to achieve a 24/7 monitoring without disturbing the customers.
